(19) United States
(12) Patent Application Publication
(10) Pub. No.: US 2004/0244503 A1
(43) Pub. Date: Dec. 9, 2004

(54) Coaxial deflection force sensor

(75) Inventors: Brian Kilmartin, Cheshire, CT (US); John E. Opie, Stony Creek, CT (US)

Correspondence Address: Elsa Keller, Siemens Corporation, Intellectual Property Department, 170 Wood Avenue South, Iselin, NJ, 08830, US

(73) Assignee: Siemens VDO Automotive Corporation

(21) Appl. No.: 10/664,750

(22) Filed: Sep. 18, 2003

Related U.S. Application Data
(60) Provisional application No. 60/475,984, filed on Jun. 5, 2003.

(51) Int. Cl. G01L 3/02; G01L 3/10

(52) U.S. Cl. 73/862.333

(57) ABSTRACT

An apparatus and method for measuring a deflecting force on a structural assembly where only one end of the assemblage is readily accessible to the application of the force. An inner torque bearing member is co-axially positioned within the outer torque bearing member and affixed at one end to the outer torque bearing member. A sense element is coupled to the structural assembly to measure the stress resulting from the force applied to the structural assembly.

### FIELD OF INVENTION

The present invention relates to torque sensors, and more particularly to measuring torque in a shaft using a single ended torque sensing apparatus and method.

### BACKGROUND

Torque sensors known in the art rely on sense elements, for example strain gauges or magnetoelastic materials, affixed to a torque bearing member, which may be shaped as a shaft, to sense torsion forces in the torque bearing member. Deformation in the microstructure of the torque bearing member caused by the applied torque, subsequently influences the sense element. Coupling torque-induced stresses into a sense element that is of magnetoelastic material, results in magnetic field changes that are proportional to the applied torque. A magnetometer disposed near such a sense element detects the magnitude and polarity of the magnetic field, can be correlated to the magnitude and polarity of the applied torque.

To ensure that the behavior of the magnetoelastic sense element accurately reflects the torque applied to the torque bearing member, the magnetoelastic sense element is usually a cylinder tightly coupled to the torque bearing member which is also a cylinder. Current torque sensors known in the art rely on a design configuration where torque is applied by a load to opposing ends of the torque bearing member and in effect, twist the torque bearing member from end to end. Each end of the torque bearing member requires a separate load to apply stress to the ends of the torque bearing member. This type of design places constraints on packaging and spatial options of the torque bearing member and its housing.

### SUMMARY OF INVENTION

The coaxial deflecting force sensor described herein measures a deflecting force response generated from a sense element coupled to a structural element undergoing such deflecting force.

It is an object of the present invention to provide an alternate approach to sensing stress and strain on a mechanical system.

It is another object of the present invention to provide a coaxial deflecting force sensor for use in a mechanical system that, if desired may allow a more compact design than aforementioned knows designs.

In accordance with one aspect of this invention, an apparatus for single ended stress measurement comprises structural members generally concentric relative to each other such that a load on either causes a stress on the other, and a sense element coupled to at least one of the structural members for generating a signal indicative the stress applied to the structural member that is coupled thereto.

In accordance with another aspect of this invention, a method for performing single ended stress measurement, the method comprises affixing a pair of generally concentric structural members relative to each other at one end thereof, coupling a sense element to at least one of the structural members, applying a load to at least one of the structural members distal the affixed end thereof, and measuring a signal generated by the sensor, and correlating same to the applied load.

In accordance with another aspect of this invention an apparatus for measuring load in a vehicle, comprises structural members generally concentric relative to each other such that a load on either causes a stress on the other, and a sense element coupled to at least one of the structural members for generating a signal indicative the stress applied to the structural member that is coupled thereto.

### BRIEF DESCRIPTION OF DRAWINGS

FIG. 1 is a perspective schematic view of a coaxial torque sensor of the present invention affixed to an outer torque bearing member.

FIG. 2 is a cross section view of the prior art torque bearing member with loads coupled at both ends with a sensing element affixed to the torque bearing member.

FIG. 3 is a cross section view of a torque bearing member of the present invention with loads attached at one end with a sensing element affixed to the outer torque bearing member.

FIG. 4 is a perspective view of a coaxial torque sensor with a sensing element affixed to the inner torque bearing member.

FIG. 5a is a perspective view of a rectangular shaped torque bearing member.

FIG. 5b is a perspective view of a square shaped torque bearing member.

FIG. 5c is a perspective view of an elliptical shaped torque bearing member.

FIG. 5d is a perspective view of a circular shaped torque bearing member

### DETAILED DESCRIPTION

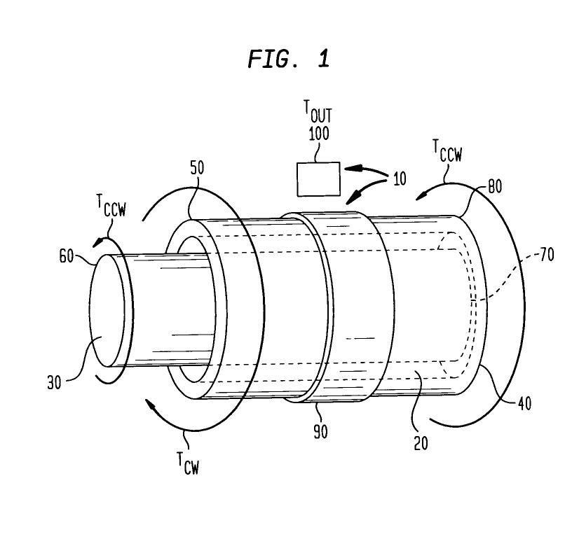

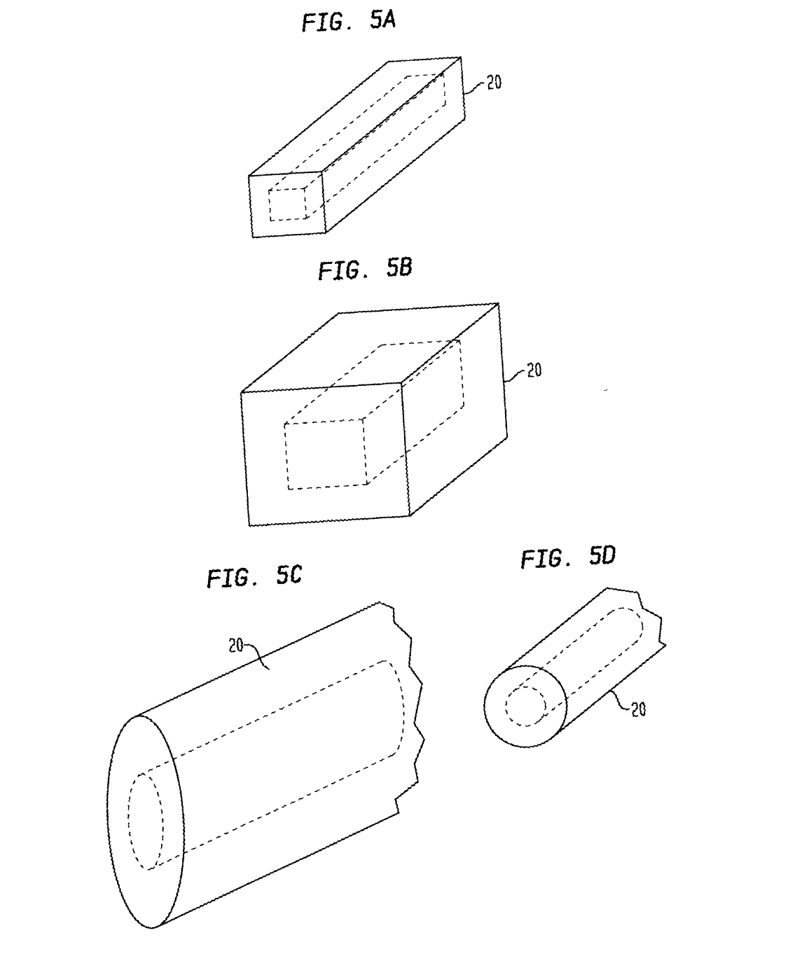

Referring to FIG. 1, the torque sensor 10 of the present invention includes a pair of coaxial concentric torque bearing members 20, 30 that are coupled only at one end 40, torque is applied to the respective uncoupled end 50 of outer torque bearing member 20 and uncoupled end 60 of the inner torque bearing member 30. The torque bearing members 20, 30 may be shaped in any desired cross section, for example, as circular, square, rectangular, or elliptical tubing as shown in FIGS. 1 and 5a-c. The inner torque bearing member 30 is generally co-axially positioned within the outer torque bearing member 20, wherein the inner torque bearing member's coupled end 70 is mechanically coupled to the outer torque bearing member's coupled end 80, at the end of the sensor 10. The length of the inner torque bearing member 30 is greater than the length of the outer torque bearing member 20, so that the uncoupled end 60 of the inner torque bearing member 30 and the uncoupled end 50 of the outer torque bearing member 20 are free and able to perform work. The inner diameter of the outer torque bearing member 20 is larger than the outer diameter of the inner torque bearing member 30. One ordinarily skilled in the art may use a type of bearing to separate the inner torque bearing member 30 and the outer torque bearing member 20 so that they maintain their coaxial spatial relationship. By varying diameters, cross sections, or wall thicknesses in the case of a torque bearing member, differing torque sensor measuring ranges and yield strengths may be attained for the torque bearing members. In the case of an outer torque bearing member 20 and inner torque bearing member 30, the ratio of strengths between the two members will be reflected in the portion of stress across each member. If both are of equal strength, they will both share the stress and deflection. If one member has a substantially higher strength value, all deflection will occur across the weaker torque bearing member. If torque is applied to the outer torque bearing member 20 in a clock wise direction, Tcw, then a counter force, Tccw, torque in a counter clockwise direction, is applied at the uncoupled end 70 of the inner torque bearing member 30. Tccw is transferred through the inner torque bearing member 30 to the opposite end of the outer torque bearing member 20, creating Tccw′, torque counter clockwise prime. Tccw is equal to Tccw′ in magnitude. The inner torque bearing member 20 extends down the center latitudinal axis of the outer torque bearing member 30 to import a counter force. The outer torque bearing member 20, thus, experiences an equal but opposite twisting force at it's coupled end (i.e. torque) 80. In this application, a sense element 90 may be comprised of a magnetoelastic is affixed to the outer torque bearing member 20 and the sense element 90 is influenced by this applied torque.

The sense element 90 cooperates with a detector 100, such as a magnetometer of known design, to form the complete torque sensor 10. The detector 100 measures change in magnetic field generated by the sense element 90 when it is deformed via torsion forces and outputs a measurement signal via leads Tout in a manner known to those skilled in the art. Other torque sense elements 90 and response detectors 100 may be used to form the torque sensor 10 as long as the torque sense element 90 generates a torque response in response to an applied torque and the response detector 100 is designed to detect the specific torque response generated by the outer torque bearing element 20 and generate a corresponding output via signal path such as Tout. The sense element 90 may have any structure that allows it to deform in a predictable manner based on the applied torque on the outer torque bearing member 20, such as a sleeve made of magnetic material or a deformable sleeve made of non-magnetic material.

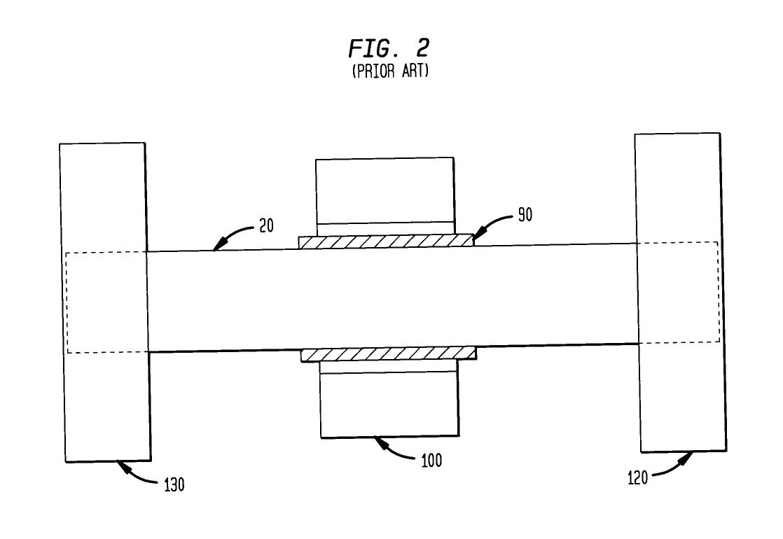

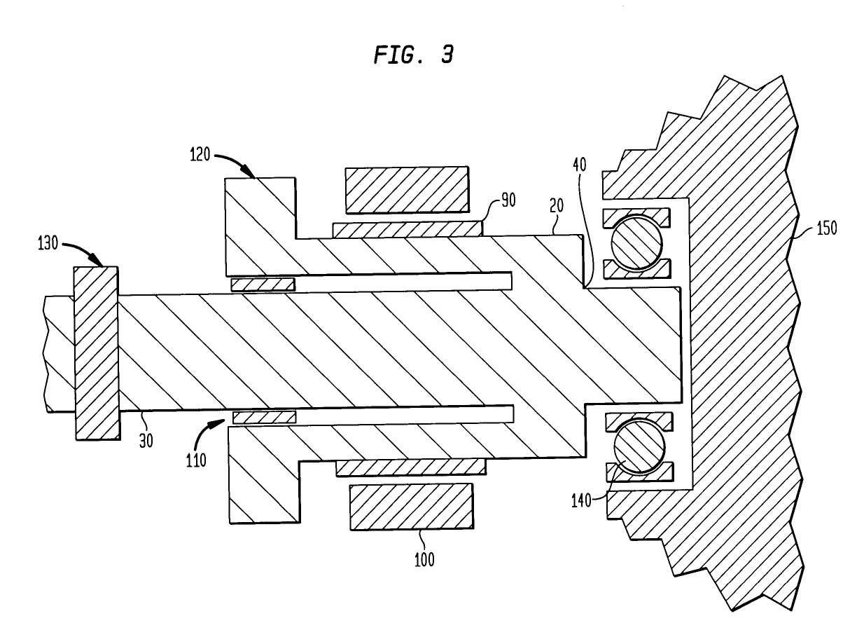

Referring to FIG. 3, representing a cross section view of the outer torque bearing member 20 coupled to inner torque bearing member 30 mounted in a housing using an optional bearing assembly 110. One skilled in the art may manufacture the inner torque bearing member 30 and outer torque bearing member 20 as one piece or as multiple parts mechanically preferable affixed firmly together to avoid slippage, slack or looseness. Affixation methods may include welding, splining, pinning or pressing. A sense element 90 is applied between the response detector 100 and the outer torque bearing element 20. The sense element 90 may be applied by methods including electroplating, electroless plating, sintering, magnaforming, welding, adhesive bonding, vapor deposition, vacuum deposition, sputtering, laser deposition, ion beam deposition, hydroforming, frictional fitting, and cladding. The optional bearing assembly 110 may be positioned between the end of first load 120 and the outer torque bearing member 30. First load 120 and second load 130 are adjacently placed next to one another as opposed to being displaced from one another as shown in FIG. 2. As indicated from the prior art in FIG. 2, outer torque bearing member 20 was connected to a first load 120 and a second load 130 at either ends of the outer torque bearing member 20. The length between first load 120 and second load 130 spans the distance of the length of the outer torque bearing element 20 and the stress is evenly distributed across the outer torque bearing member 20. In FIG. 3, the placement of first load 120 is in close proximity to the second load 130 thereby occupying less space in the housing. In this embodiment, the stress is distributed linearly along the outer torque bearing element 20 assuming the cross section of outer torque bearing member is consistent over its length. If the cross section of the outer torque bearing element 20 is varied then the stress will not be not uniform during the loading from end to end which may be preferred by the user. A non uniform cross section or even offset, non co-axial torque bearing members 20, 30 can be compensated through calculations, if preferred by one skilled in the art. First load 120 and second load 130 are equal in magnitude and opposite in directional force. The twisting force distributes itself between first load 120 and second load 130. An interface element 140 may be a ball bearing, a roller, or a bushing to interface the coupled end 40 the torque bearing elements 20, 30 with the housing structure 150. The coupled end 40 of the torque bearing elements 20, 30 is therefore not available to input or output work.

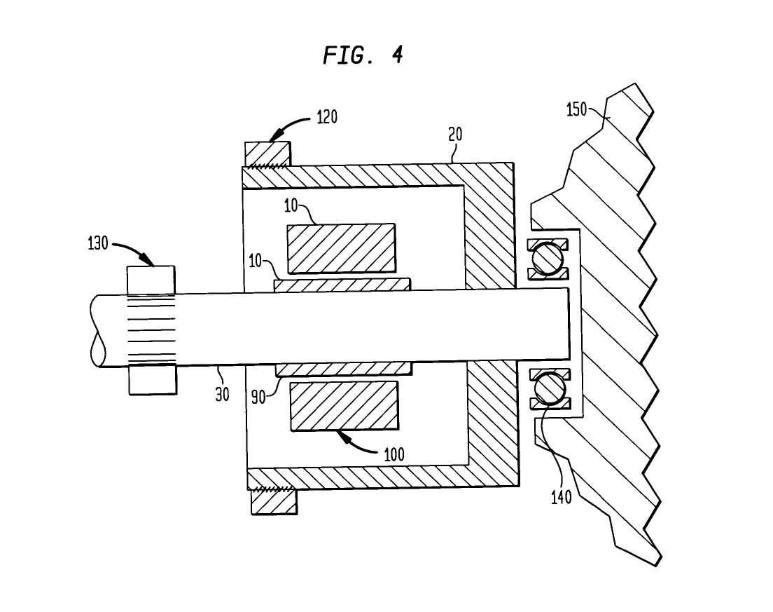

Referring to FIG. 4, an alternative embodiment shows sense element 90 affixed to inner torque bearing member 30. Stress is distributed evenly across the inner torque bearing member element 30. As previously described with respect to the embodiment of FIG. 3, the torque bearing assembly may be manufactured as one component or as multiple parts affixed together. The outer diameter of outer torque bearing member 20 must be greater than the outer diameter of the inner torque bearing member 30 in addition to the height of the response detector 100 affixed to the inner torque bearing member 30. The response detector 100, such as a magnetometer of known design, is mounted proximal to the sense element 90 to complete the torque sensor 10. One skilled in the art may mount the response detector 100 to the inner torque bearing member 30 using external brackets.

Note that although the embodiments shown above illustrate a magnetoelastic sense element 90, the sense element 90 is not limited to a magnetoelastic material. Other sense elements 90 such as a strain gage may also be used by others skilled in the art. Additionally, the present invention is not limited to a rotary torque bearing member. A non-rotary torque bearing member may also be used by others skilled in the art.

While the present invention has been disclosed with reference to certain embodiments, numerous modifications, alterations, and changes to the described embodiments are possible without departing from the sphere and scope of the present invention. Accordingly, it is intended that the present invention not be limited to the described embodiments and equivalents thereof.

1. An apparatus for single ended stress measurement, comprising:
nested structural members such that a load on either causes a stress on the other; and
a sense element coupled to at least one of the structural members for generating a signal indicative the stress applied to the structural member that is coupled thereto.

2. The apparatus of claim 1 wherein the nested structural members comprises an inner torque bearing member inserted within an outer torque bearing member.

3. The apparatus of claim 1, wherein the sense element is coupled to the outer torque bearing member.

4. The apparatus of claim 3, wherein the sense element is magnetoelastic based or a strain gage based.

5. The apparatus of claim 1, wherein a response detector is in communication with the sense element.

6. The apparatus of claim 1, wherein the response detector is a magnetometer.

7. The apparatus of claim 2, wherein an inner radius of the outer torque bearing member is greater than an outer radius of the inner torque bearing member

8. The apparatus of claim 2, wherein the outer torque bearing member is shaped as a circular, square, rectangular, or elliptical tubing.

9. The apparatus of claim 2, wherein the inner torque bearing member is shaped as a circular, square, rectangular or elliptical tubing.

10. The apparatus of claim 2, wherein the outer torque bearing member is a rotary or non-rotary torque bearing member.

11 The apparatus of claim 2, wherein the inner torque bearing member is a rotary or non-rotary torque bearing member.

12 The apparatus of claim 2, wherein a length of the inner torque bearing member is greater than a length of the outer torque bearing member.

13 The apparatus of claim 1, wherein the sense element is coupled to the inner torque bearing member.

14 The apparatus of claim 13 wherein an inner radius of the outer torque bearing member is greater than the outer radius of the sense element coupled to the inner torque bearing member and in communication with the response detector.

15 The apparatus of claim 1, wherein the stress is a torque.

16 A method for performing a single ended stress measurement, the method comprising:
affixing a pair of generally concentric structural members relative to each other at one end thereof;
coupling a sense element to at least one of the structural members;
applying a load to at least one of the structural members distal the affixed end thereof; and
measuring a signal generated by the sense element, and correlating same to the applied load.

17. The method of claim 16 wherein the structural members comprise an inner torque bearing member inserted within an outer torque bearing member.

18. The method of claim 16, wherein the sense element is coupled to the outer torque bearing member.

19. The method of claim 16, wherein the sense element is a magnetoelastic based or strain gage based.

20. The method of claim 16, wherein a response detector is in communication with the sense element.

21. The method of claim 20, wherein the response detector is a magnetometer.

22. The method of claim 17, wherein the outer torque bearing member is shaped as a circular, square, rectangular, or elliptical tubing.

23. The method of claim 17, wherein the inner torque bearing member is a shaped as a circular, square, rectangular, or elliptical tubing.

24. The method of claim 17, wherein the outer torque bearing member is a rotary or non-rotary torque bearing member.

25. The method of claim 17, wherein the inner torque bearing member is a rotary or non-rotary torque bearing member.

26. The method of claim 17, wherein an inner radius of the outer torque bearing member is greater than an outer radius of the inner torque bearing member.

27. The method of claim 17, wherein a length of the inner torque bearing member is greater than a length of the outer torque bearing member.

28. The method of claim 17, wherein the sense element is coupled to the inner torque bearing member.

29. The method of claim 28, wherein an inner radius of the outer torque bearing member is greater than the outer radius of a sense element coupled to the inner torque bearing member and in communication with the response detector.

30. The method of claim 16, wherein the stress is a torque.

31. An apparatus for measuring load in a vehicle, comprising:
structural members generally concentric relative to each other such that a load on either causes a stress on the other; and
a sense element coupled to at least one of the structural members for generating a signal indicative the stress applied to the structural member that is coupled thereto.

32. The apparatus of claim 31, wherein the structural members comprises an inner torque bearing member inserted within an outer torque bearing member.

33. The apparatus of claim 31, wherein the sense element is coupled to the outer torque bearing member.

34. The apparatus of claim 31, wherein the sense element is magnetoelastic based or a strain gage based.

35. The apparatus of claim 31, wherein a response detector is in communication with the sense element.

36. The apparatus of claim 35, wherein the response detector is a magnetometer.

37. The apparatus of claim 32, wherein an inner radius of the outer torque bearing member is greater than an outer radius of the inner torque bearing member

38. The apparatus of claim 32, wherein the outer torque bearing member is shaped as a circular, square, rectangular, or elliptical tubing.

39. The apparatus of claim 32, wherein the inner torque bearing member is shaped as a circular, square, rectangular or elliptical tubing.

40. The apparatus of claim 32, wherein the outer torque bearing member is a rotary or non-rotary torque bearing member.

41. The apparatus of claim 32, wherein the inner torque bearing member is a rotary or non-rotary torque bearing member.

42. The apparatus of claim 32, wherein the inner torque bearing member is a non-rotary torque bearing member.

43. The apparatus of claim 32, wherein a length of the inner torque bearing member is greater than a length of the outer torque bearing member.

44. The apparatus of claim 31, wherein the sense element is coupled to the inner torque bearing member.

45. The apparatus of claim 44, wherein an inner radius of the outer torque bearing member is greater than the outer radius of the sense element coupled to the inner torque bearing member in communication with the response detector.

46. The apparatus of claim 31, wherein the stress is a torque.

47. The apparatus of claim 31, wherein the vehicle comprises a wheeled means for transport.
